(19) United States
(12) Patent Application Publication
(10) Pub. No.: US 2009/0241828 A1
(43) Pub. Date: Oct. 1, 2009

(54) Mechanics for haybella tech automated distress-flag system

(76) Inventor: Michael Alan Navarra, JR., Lodi, CA (US)

Correspondence Address: MICHAEL NAVARRA, JR., 327 EUREKA AVE., LODI, CA, 95240-1135, US

(21) Appl. No.: 12/055,272

(22) Filed: Mar. 25, 2008

(51) Int. Cl. G09F 17/00

(52) U.S. Cl. 116/173

(57) ABSTRACT

This invention pertains to the boating industry. More specifically the sports realm. It is intended to automatically control the flag. knowing when a boarder is up or down with out any electronics use is this inventions most unique aspect. It specifically usestension to identify the status of the boarder, skier, etc. weather they are up riding, or down in the water. It is designed to look nice while giving the boaters a more enjoyable and hassle free time while insuring the safety of their friends or family to the highest degree possible which is mounting at the top of the tower where there are no object obstructing the view.

The invention is for the mechanics for the Haybella Tech Inc. Automated distress flag system. The way it works is when tensionis applied to the cable 23 (the rope is being pulled) it then makes the angled round bar 11 slide back depressing the gas spring 15 which has constant outward pressure. The angled round bar 11 is attached to the angled control arm 5 which in turn retracts the flat blade end connector. Inserted in through the yoke end 2 and the shaft collar 3 is the quick release air fitting 20,pipe connector 19, and the round shaft bar 18, (now one part) the flag holder. The shaft collar 3 is secured to the flag holder with an alien screw so that it may not freely spin inside it as it does inside the yoke end 2. That flag holder then retracts 90 degrees putting the flag in a down position. This flag will remain in that position until the tension on the cable 23 is released (the skier falls down). At that time the gas spring 15 is aloud to fully extend out raising the flag to the full up-right position. Numbers correspond with FIG. 1.

To assemble the mechanics you must start with placing the yoke end 2 onto the base plate 1 centering the shaft hole approximately 3¾ back from the bend and the hole edge approximately 1/16 from the plates edge. Press back end of the yoke end 2 down till it touches the plate and weld. Then weld where it is touching the plate in the center of the yoke end 2 on both sides. Then you place the gas spring mounting bracket 17 on the plate. Using the center hole, place the gas spring ball connector 17 approximately ⅝ from the right side and approximately ⅞ from the bottom. Weld the gas spring ball connector 17 on all edges and cut off excess. Now you must take the flat plate 14 and center it on the bottom of the square tubing 13 and weld them together. Take the round bar sleeve 12 and center it on top of the square tubing 13 and weld both sides. Now take the gas spring 15 and screw the ball end connector 16 on to the bottom using lock tight on the threads. Next take the flat blade end connector 6 and screw it on to the top of the gas spring 15 using lock tight on the threads. Next put the angled round bar 11 through the flat blade connector 6 so it's downward bend is through the loop of the flat blade end connector 6. Now you take the cotter pin 8 and put it through the inside hole at the top of the angled round bar 11 and bend around the pin arms. Now slip the angled control arm 5 onto the angled round bar 11 with the bend going away from the angled round bar 11. Next put the cotter pin 7 through the outside hole at the top of the angled round bar 11, bend around the pin arms. Now the angled control arm 5 should be free to rotate but not come off. Now take the square tubing 13 (which should have the round bar sleeve 12 and the flat plate 14 welded to it) and slip the gas spring 15 through the square tubing 13 as well as the angled round bar 11 through the round bar sleeve 12. Now you must compress the gas spring 15 so that the ball end connector 16 can snap onto the gas spring mounting bracket 17, the flat plate 14 can sit flat on the base plate 1 and the flat blade end connector 6 is resting on the upward bend of the base plate 1. Weld the ball end connector 16 to the gas spring mounting bracket 17. Adjust the flat plate 14 so that it's right side edge is approximately 5/16 from the right side edge of the base plate 1 and its bottom edge is approximately 5¾ up from the bottom edge of the base plate 1. Weld into place on both sides. Now put the bolt 9 through the hole in the angled control arm 5 and then put the straight control arm 4 on the bolt 9. Screw the nut 10 onto the bolt 9 securing the angled control arm 5 and the straight control arm 4 together. To get the right angle you must tack weld the straight control arm 4 to the shaft collar 3 in place. In order to do that you must put the shaft collar 3 inside the yoke end 2 and slide in a dummy shaft bar to hold the shaft collar in place 3 in place. Now touch the straight control arm 4 to the shaft collar 3 centering them on each other (make sure the allen screw in the shaft collar 3 is facing down so it is accessible through the hole in the base plate 1) and tack weld. Now pull the straight control arm 4 and shaft collar 3 out and finish welding. Sand the sides of the shaft collar 3 so no weld is sticking out past the edge. After putting the straight control arm 4 and shaft collar 3 back in, use the dummy shaft bar again to hold in place for installation of the reverse protector 24. The reverse protector 24 is slid up under the straight control arm 4 preventing the joint of the straight control arm 4 and angled control arm 5 from inverting and locking. once you have placed the reverse protector 24 under the straight control arm 4 so they are touching, you weld the reverse protector 24 into place. Now you slide the cable crimps 21 and 22 onto the cable 23 and loop the cable 23 through the hole in the bottom of the angled round bar 11. Put the cable 23 back through the cable crimps 21 and 22 with approximately 1/16 sticking out of the second cable crimp 22. Now crimp the cable crimps 21 and 22 down. Next you screw the quick release air fitting 20 into the top of the pipe connector 19. Now slide the round shaft bar 18 into the bottom of the pipe connector 19 and weld together all the way around. Finally you drill an approximately 3/16 hole that goes through the bottom of the pipe connector 19 and into the bottom of round shaft bar 18. Fill that hole with weld to lock the pipe connector 19 and the round shaft bar 18 together. Heavily grease all moving parts and joints with high temp brake grease.
All measurements approximate, bold, and in inches.
All part numbers corresponding with FIG. 1 are bold.

### CROSS REFERENCE APPLICATIONS

| | | |
|---|---|---|
| 3602188 | July 1971 | Penaflor |
| 4640213 | February 1987 | Iugo |
| 7013823 | March 2006 | Daugherty |
| 5408221 | April 1995 | Carasella |
| 3735724 | May 1973 | Miller |
| 5771836 | June 1998 | Crouse |

### BACKGROUND OF THE INVENTION

This invention pertains to the field of boating sports. It is used toalert other boaters of a downed person in the water. It may be used for water sking, wake-boarding, tubing etc.The problems it is intended to solve are the job of holding theflag in the air by hand, the low visibility of the flag being held inside the boat creating a safety concern. Also the forgetfulness to raise the flag when the person goes down. The time delay in the raising of a flag by a person, as well as the forgetfulness to continue to hold up the flag while the person is down or you have an object in the water such as a rope or tube. Also it answers the boat is swimming?”

As the law states in most states where boating is a popular choice for recreation, a red or orange flag no less than 12 inches in diameter on each side, in the shape of a square or rectangle, must be mounted or displayed in such a mannor as to be seen from every direction. This invention meets and exceeds those requirments.

### SUMMARY OF THE SMART FLAG

The general idea of the smart flag is to assure a flag is raised at all times necessary with out involving a person actually hold one in the air. an automatic flag. The problems it intends to solve are 1. Eliminate a person from have to hold the flag in the air by hand. 2. Creates maximum visibility by mounting on top of the tower versus the low visibility of a person sitting in a boat. 3. It solves the safety issue of a person forgetting to raise the flag, as well as forgetting to continue to hold it up the entire time someone or something is in the water. 4. The time delay in a person falling and someone realizing, finding the flag and raising it. 5. It also answers the question of “who will hold the flag while everyone on the boat is swimming?”1 Is solved by the flag being a mounted object rather than a held object. 2 Is solved by the flag being mounted on the highest point of the boat leaving nothing to obstruct the view of the flag. 3 Is solved by the flag working completely on its own. Knowing by tension, weather the boarder is up or down and acting accordingly. 4 Is solved by the constant pressure to raise the flag therefore making it rise the second a boarder is down leaving little gap in the time between the fall and the flag in full upright position. 5 Is solved by the flag being attached to the tower and being a fix object, not needing any person to attend to it. Opening everyone on the boat to do as they please with out any worry or concern of safety. This product not only provides convenience as well as an attractive new addition to you boat, it provides unparalleled safety for your family and friends.

### BRIEF DESCRIPTION OF DRAWINGS

FIG. 01. This is a depiction of how the mechanics are assembled. It shows how all the parts fall together. Also it has each part numbered to better explain the process.

FIG. 02. This is an aerial view of the mechanics assembled. It depicts all the parts in their resting position.

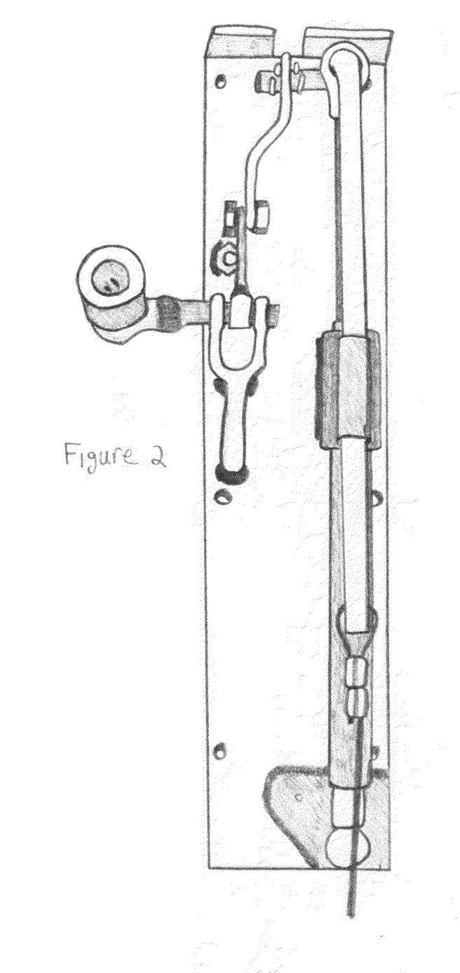

FIG. 03. This is a view from the right side of the assembled mechanics. It shows the resting position of the mechanics which would be flag up.

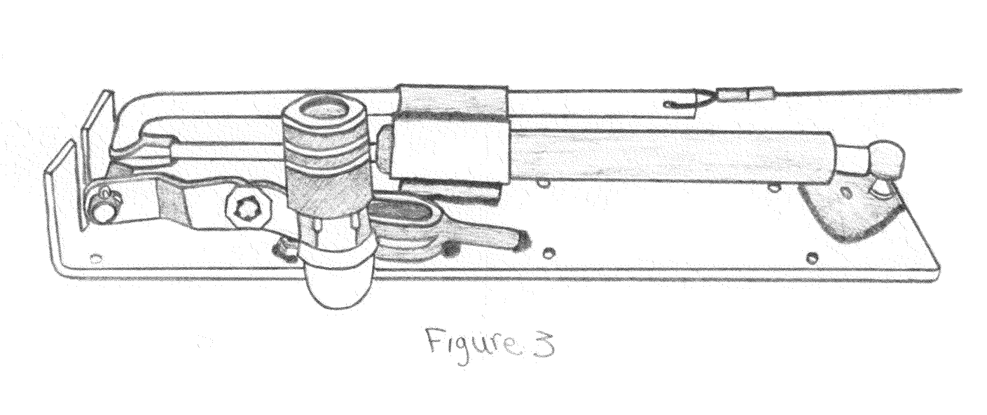

FIG. 04. This is a view from the right side of the assembled mechanics. It shows the retracted position of the mechanics which would be flag down.

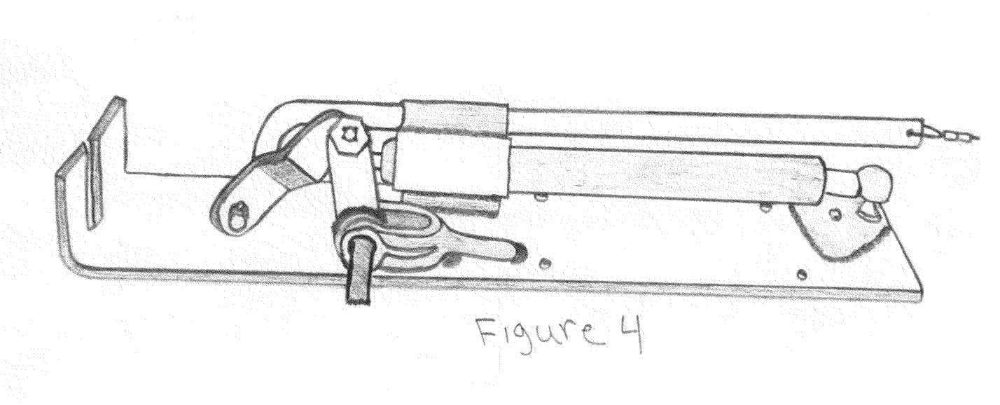

### DETAILED DESCRIPTION OF THE INVENTION

This is the mechanics for a automated distress flag. This will be mounted inside a casing that mounts to the tower of a boat. shown in patent application Ser. No 29/305,317, Automated distress-flag system for towing sports boats. It is intended to take the job of flagging while a person is down or someone or something is in the water. No person is needed to operate this, only thing necessary is to simply look up and make sure it is working. fabrication and assembly of these mechanics are as follows.

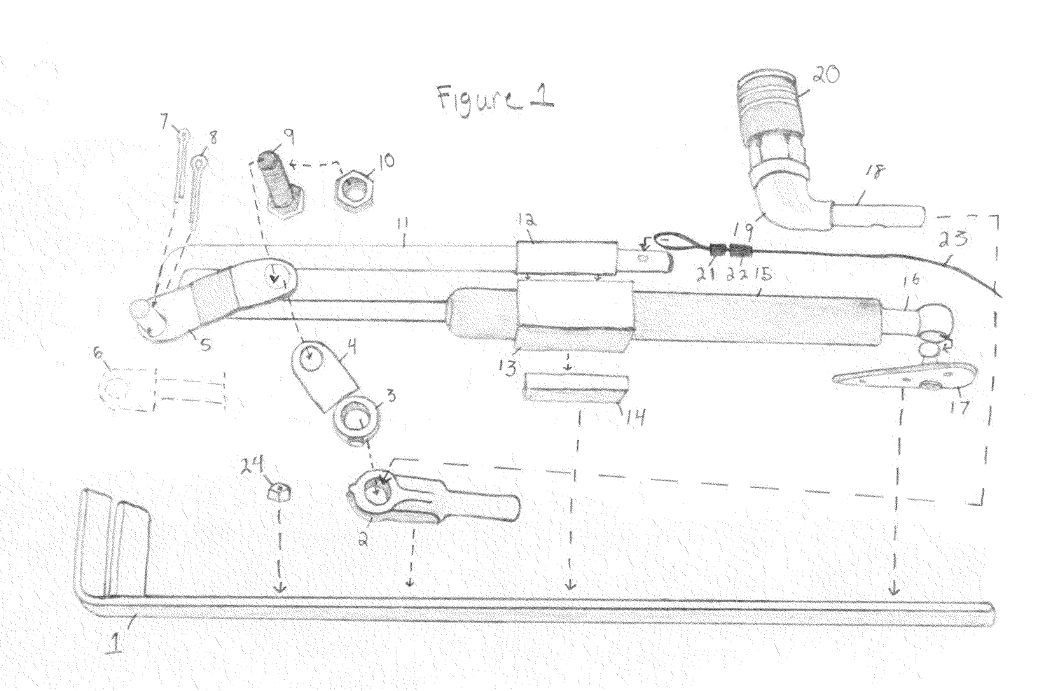

To assemble the mechanics you must start with placing the yoke end 2 onto the base plate 1 centering the shaft hole approximately 3¾ back from the bend and the hole edge approximately 1/16 from the plates edge. Press back end of the yoke end 2 down till it touches the plate and weld. Then weld where it is touching the plate in the center of the yoke end 2 on both sides. Then you place the gas spring mounting bracket 17 on the plate. Using the center hole, place the gas spring ball connector 17 approximately ⅝ from the right side and approximately ⅞ from the bottom. Weld the gas spring ball connector 17 on all edges and cut off excess. Now you must take the flat plate 14 and center it on the bottom of the square tubing 13 and weld them together. Take the round bar sleeve 12 and center it on top of the square tubing 13 and weld both sides. Now take the gas spring 15 and screw the ball end connector 16 on to the bottom using lock tight on the threads. Next take the flat blade end connector 6 and screw it on to the top of the gas spring 15 using lock tight on the threads. Next put the angled round bar 11 through the flat blade connector 6 so it's downward bend is through the loop of the flat blade end connector 6. Now you take the cotter pin 8 and put it through the inside hole at the top of the angled round bar 11 and bend around the pin arms. Now slip the angled control arm 5 onto the angled round bar 11 with the bend going away from the angled round bar 11. Next put the cotter pin 7 through the outside hole at the top of the angled round bar 11, bend around the pin arms. Now the angled control arm 5 should be free to rotate but not come off. Now take the square tubing 13 (which should have the round bar sleeve 12 and the flat plate 14 welded to it) and slip the gas spring 15 through the square tubing 13 as well as the angled round bar 11 through the round bar sleeve 12. Now you must compress the gas spring 15 so that the ball end connector 16 can snap onto the gas spring mounting bracket 17, the flat plate 14 can sit flat on the base plate 1 and the flat blade end connector 6 is resting on the upward bend of the base plate 1. Weld the ball end connector 16 to the gas spring mounting bracket 17. Adjust the flat plate 14 so that it's right side edge is approximately 5/16 from the right side edge of the base plate 1 and its bottom edge is approximately 5¾ up from the bottom edge of the base plate 1. Weld into place on both sides. Now put the bolt 9 through the hole in the angled control arm 5 and then put the straight control arm 4 on the bolt 9. Screw the nut 10 onto the bolt 9 securing the angled control arm 5 and the straight control arm 4 together. To get the right angle you must tack weld the straight control arm 4 to the shaft collar 3 in place. In order to do that you must put the shaft collar 3 inside the yoke end 2 and slide in a dummy shaft bar to hold the shaft collar in place 3 in place. Now touch the straight control arm 4 to the shaft collar 3 centering them on each other (make sure the allen screw in the shaft collar 3 is facing down so it is accessible through the hole in the base plate 1) and tack weld. Now pull the straight control arm 4 and shaft collar 3 out and finish welding. Sand the sides of the shaft collar 3 so no weld is sticking out past the edge. After putting the straight control arm 4 and shaft collar 3 back in, use the dummy shaft bar again to hold in place for installation of the reverse protector 24. The reverse protector 24 is slid up under the straight control arm 4 preventing the joint of the straight control arm 4 and angled control arm 5 from inverting and locking. once you have placed the reverse protector 24 under the straight control arm 4 so they are touching, you weld the reverse protector 24 into place. Now you slide the cable crimps 21 and 22 onto the cable 23 and loop the cable 23 through the hole in the bottom of the angled round bar 11. Put the cable 23 back through the cable crimps 21 and 22 with approximately 1/16 sticking out of the second cable crimp 22. Now crimp the cable crimps 21 and 22 down. Next you screw the quick release air fitting 20 into the top of the pipe connector 19. Now slide the round shaft bar 18 into the bottom of the pipe connector 19 and weld together all the way around. Finally you drill an approximately 3/16 hole that goes through the bottom of the pipe connector 19 and into the bottom of round shaft bar 18. Fill that hole with weld to lock the pipe connector 19 and the round shaft bar 18 together. Heavily grease all moving parts and joints.
All measurements approximate, bold, and in inches.
All part numbers corresponding with FIG. 1 are bold.

What is claimed is:

1. The use of these mechanics as means to raise and lower a distress-flag for boating with tension from the rope which is affixed to a pylon connected to the tower.

2. The mounting of these mechanics in inside a casing (application Ser. No. 29/305,317) which is then mounted to the boat tower directly in line with the towing pylon.

3. The design and araingment of the parts of the mechanics as to be used for a caution flagging system. claim this mechanical design in all forms stated above and in all documents contained in this application.
